(19) United States
(12) Patent Application Publication
(10) Pub. No.: US 2026/0064770 A1
(43) Pub. Date: Mar. 5, 2026

(54) METHOD AND SYSTEM FOR MANAGING TRANSMISSIONS IN AN ENVIRONMENT

(71) Applicant: ESKI Inc., Montreal (CA)

(72) Inventors: Vincent Leclerc, Montreal (CA); Jean-Sébastien Rousseau, Pointe-Claire (CA); Nikolas Sigouin, Montreal (CA)

(73) Assignee: ESKI Inc., Montreal (CA)

(21) Appl. No.: 18/824,682

(22) Filed: Sep. 4, 2024

(51) Int. Cl. G06F 16/68; G06F 16/783

(52) U.S. Cl. CPC G06F 16/686; G06F 16/7834

(57) ABSTRACT

The methods and systems described herein may be utilized to synchronize the generation of a distributed manifestation with a production in an environment. Synchronizing the generation of a distributed manifestation with a production may include recognizing the occurrence of one or more events in a series of events of the production, such as through on one or more characteristics of the events. Recognition of the occurrence of the event(s) may enable identification of points in time at which to emit electromagnetic signals so that receiving units in the environment express a state coincident with the production.

### BACKGROUND INFORMATION

Commonly assigned U.S. Pat. No. 8,740,391 (hereinafter “the '391 patent”) discloses a system for providing a distributed manifestation within an environment. An environment may include, as examples, a concert stage, arena, lecture hall, theater, movie theater, open-air venue, or any other suitable structure and/or setting. The system may include one or more emission units which are configured to transmit signals to a number of receiving units in the environment. The receiving units are configured to manifest a state change in response to processing received signals to create, for example, visual effects (e.g., changes in color, video, the presence or absence of light or an image, etc.) and/or effects which involve sound, shape, odor and/or other sensory stimuli. A change in state may occur for a fixed period of time, or be dynamic (e.g., receiving units may change state at some point after receiving signals, and/or may change state at a time and/or in a way which varies in some way based on other input). In some embodiments disclosed by the '391 patent, a receiving unit may comprise a wearable device, which is a device or collection of components that may be worn, carried or otherwise transported by a user, such as an attendee to a production.

### SUMMARY

Some embodiments of the invention are directed to a method of generating a distributed manifestation coincident with a production. The distributed manifestation comprises a plurality of receiving units expressing a state as a result of processing electromagnetic signals received from at least one emission unit. The production comprises a plurality of events occurring in a predetermined sequence. The method comprises acts of: (A) recognizing occurrence of a particular event of the plurality of events, the recognizing comprising determining that the particular event includes one or more sounds; (B) determining when in the predetermined sequence the particular event is to occur; (C) determining at least one point in time during the production at which to send electromagnetic signals to the plurality of receiving units to produce at least a portion of the distributed manifestation; and (D) causing electromagnetic signals to be sent to the plurality of receiving units during the production at the determined at least one point in time.

Some embodiments are directed to a system for controlling generation of a distributed manifestation coincident with a production. The distributed manifestation comprises a plurality of receiving units expressing a state as a result of processing electromagnetic signals. The production comprises a plurality of events occurring in a predetermined sequence. The system comprises: at least one emission unit configured to emit electromagnetic signals to the plurality of receiving units; and at least one computer processor, programmed to: recognize an occurrence of a particular event of the plurality of events, the recognizing comprising determining that the particular event includes one or more sounds; determine when in the predetermined sequence the particular event is to occur; determine at least one point in time during the production at which to send electromagnetic signals to the plurality of receiving units to produce at least a portion of the distributed manifestation; and cause the at least one emission unit to emit electromagnetic signals to the plurality of receiving units during the production at the determined at least one point in time.

Some embodiments are directed to at least one computer-readable storage medium having instructions stored thereon which, when executed by at least one computer processor, cause the at least one computer processor to perform a method of generating a distributed manifestation coincident with a production. The distributed manifestation comprises a plurality of receiving units expressing a state as a result of processing electromagnetic signals received from at least one emission unit. The production comprises a plurality of events occurring in a predetermined sequence. The method comprises acts of: (A) recognizing occurrence of a particular event of the plurality of events, the recognizing comprising determining that the particular event includes one or more sounds; (B) determining when in the predetermined sequence the particular event is to occur; (C) determining at least one point in time during the production at which to send electromagnetic signals to the plurality of receiving units to produce at least a portion of the distributed manifestation; and (D) causing electromagnetic signals to be sent to the plurality of receiving units during the production at the determined at least one point in time.

### BRIEF DESCRIPTION OF THE DRAWINGS

Aspects of the present disclosure will be described with respect to the accompanying drawings. The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 depicts a representative process for generating a distributed manifestation coincident with a production, according to some embodiments;

FIG. 2 is a block diagram of a representative system for generating a distributed manifestation coincident with a production, according to some embodiments;

FIG. 3A depicts a representative arrangement of components for generating a distributed manifestation in an environment coincident with a production occurring in the environment, according to some embodiments;

FIG. 3B depicts another representative arrangement of components for generating a distributed manifestation in an environment coincident with a production occurring in the environment, according to some embodiments;

FIGS. 3C-3D schematically depicts the interaction between a representative system and events occurring in an environment for generating a distributed manifestation in the environment, according to some embodiments;

FIG. 4 depicts a representative process for using a machine learning model to discern one or more characteristics of an event, according to some embodiments;

FIG. 5 depicts a representative process for preprocessing audio data to account for one or more characteristics of an environment in which a production takes place, according to some embodiments;

FIG. 6 depicts a representative process for training a machine learning model to discern one or more characteristics of an event in a production, according to some embodiments;

FIG. 7 depicts a representative process for identifying points in time at which to send electromagnetic signals to receiving units to produce a distributed manifestation coincident with a production, according to some embodiments; and

FIG. 8 depicts an illustrative depiction of an exemplary distributed manifestation produced coincident with a production, according to some embodiments.

### DETAILED DESCRIPTION

The Assignee has appreciated the desirability of enabling a distributed manifestation to be synchronized with a production comprising a plurality of events occurring in a predetermined sequence. Such a production may take any of numerous forms. For example, a production comprising a plurality of events in a predetermined sequence may be a movie, a concert, a show, an exhibit, and/or any other predefined, coordinated combination of auditory, visual, haptic and/or other stimuli.

The Assignee has also appreciated that synchronizing a distributed manifestation with a production may be complicated even when the production comprises a series of events that occur in predetermined sequence. As one example, the production may be interrupted as events are occurring, such as when the projector in a movie theater malfunctions during playback of a movie, or a musical artist stops a concert during a song, or delays the start of a next song, to interact with fans in the crowd. As another example, the timing at which events in the sequence occur may be altered, for any of numerous reasons. For example, the projector in a movie theater may play a movie faster or slower than anticipated, and/or at a speed which varies over time, due to mechanical and/or other issues.

The Assignee has further appreciated the desirability of precisely synchronizing a distributed manifestation with a production. In this respect, the Assignee has appreciated that if a portion of the distributed manifestation does not occur at precisely the right time to coincide with an event in the production, the distributed manifestation may not only not add to the experience of an attendee at the production, but in fact it may detract from that experience. For example, if a distributed manifestation is supposed to include a receiving unit lighting up at the same time an explosion occurs during a movie, and the receiving unit lights up before the explosion occurs, then this may reveal to the attendee that something dramatic is about to occur before it happens, in a way that neither the theater operator nor the attendee appreciates. If the receiving unit were to light up after the explosion occurs, then the attendee may consider it more of a distraction than something which adds to the overall experience of attending the movie.

As such, the Assignee has appreciated the desirability of enabling a distributed manifestation to be synchronized, and to remain synchronized, with a production comprising events occurring in a predetermined sequence despite the myriad circumstances which may cause the production to be interrupted and/or the timing at which events of the production occur to be altered over time. In this respect, some embodiments of the invention are directed to systems and methods for recognizing the occurrence of a particular event during a production, and determining where in the overall sequence the particular event occurs, and then determining when electromagnetic signals are to be emitted so as to produce one or more portions of a distributed manifestation which coincide with an event of the production. Recognition that a particular event is occurring may be performed in any of numerous ways, such as by recognizing the occurrence based on one or more characteristics of the event. For example, if it is known that an event comprises a sequence of sounds (e.g., the dialogue, sound effects, soundtrack, etc. of a scene during a movie, or the lyrics and melody of a song during a concert), then occurrence of the event may be recognized based at least in part on occurrence of the sounds. If it is known that an event comprises certain visual stimuli (e.g., patterns of light which are characteristic of a scene during a movie, or light effects occurring during an exhibit), then occurrence of the event may be recognized based at least in part on occurrence of the visual stimuli. The presence of one or more characteristics of an event (e.g., sounds, visuals, haptics, olfactory effects, and/or any other characteristic(s)) may be determined in any suitable fashion. In some embodiments of the invention, one or more machine learning models may be employed to recognize characteristics of an event, such as one or more sequences of sounds known to take place during the event, based on audio data captured during the production. However, it should be appreciated that embodiments of the invention are not limited to employing one or more machine learning models (as any suitable technology may be used, whether now known or later developed), or limited to using any particular characteristic(s) of an event to recognize its occurrence.

In some embodiments, upon recognizing occurrence of a particular event, a determination is made where in the overall sequence of events the particular event lies, so that a determination can then be made when one or more signals are to be emitted to produce a portion of the distributed manifestation. For example, some embodiments may determine that a signal or set of signals should be emitted at a certain point in time to cause a portion of the distributed manifestation to coincide with an event of the production. In some embodiments, the event with which the portion of the distributed manifestation is to coincide may be the one that is recognized, such that signals are caused to be emitted in real-time or near real-time to cause the portion of the distributed manifestation to coincide with the recognized event. In some embodiments, the event with which the portion of the distributed manifestation is to coincide may be one which is to occur after the recognized event in the overall sequence, so that signals are caused to be emitted at some time after recognition occurs. Embodiments of the invention are not limited to any particular mode(s) of implementation.

Some embodiments of the invention may employ measures to account for the particular physical characteristics of the environment in which the distributed manifestation is to take place, and/or the infrastructure and equipment used to produce it. For example, some embodiments configured to recognize occurrence of an event based at least in part on sound may employ measures to preprocess audio data to aid in event recognition, as described in further detail below. As another example, some embodiments may employ measures to account for the particular capabilities of the hardware and/or software components used to produce a distributed manifestation. For example, if it is known that one or more of those components may introduce a time lag between when instructions are issued to emit signals and when the signals are actually sent, then some embodiments may account for that lag by timing the issuance of instructions so that signals are emitted and a portion of the distributed manifestation is produced so as to precisely coincide with an event of the production, as intended. This feature of some embodiments of the invention is also described in greater detail below. Other measures used to account for the particular physical characteristics of the environment in which the distributed manifestation is to take place, and/or the infrastructure and equipment used to produce it, are described below.

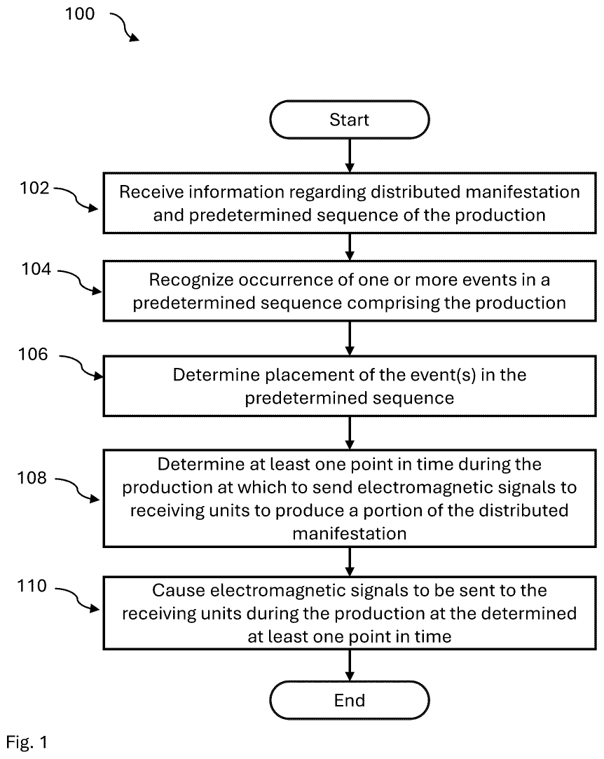

FIG. 1 depicts a representative process 100 for generating a distributed manifestation coincident with a production, the distributed manifestation comprising a plurality of receiving units expressing a state as a result of processing electromagnetic signals received from at least one emission unit, according to some embodiments. At the start of representative process 100, information regarding the production and the distributed manifestation to be produced coincident with the production may be received at act 102. In some embodiments, the information regarding the production may include the predetermined sequence of events and information related to the events of the predetermined sequence (e.g., a duration of each event, an order for the events in the sequence, etc.). Information regarding the distributed manifestation may include the effects which are to be produced coincident with the various events of the predetermined sequence, the signals that are to be sent to produce the effects, the duration and timing of the effects, or any other suitable information. In some embodiments, the information may include information associated with the hardware components used to produce the production and the distributed manifestation including, but not limited to, processing speeds, configuration of components, or any other suitable information.

In some embodiments, the information may be received at act 102 received prior to the start of the production and may be stored in the memory of one or more computing devices, in remote storage, and/or in any suitable storage facilities. Additionally or alternatively, in some embodiments, information may be received during the production, such as in real time as events of the production occur. For example, information received during the production may include audio data, visual data, other data captured via one or more sensors or instruments, physical cues, or other information associated with the production.

Representative process 100 then proceeds to act 104, wherein the occurrence of one or more particular events in a predetermined sequence comprising a production is recognized.

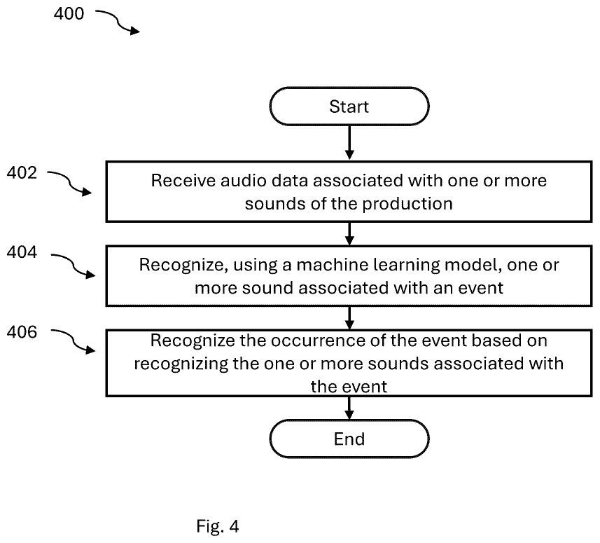

Recognizing the occurrence of one or more particular events of the production may be accomplished in any suitable fashion. In some embodiments, the occurrence of an event may be recognized through the identification that one or more characteristics of the event (e.g., one or more sounds, visual cues, physical cues, and/or other characteristics) are present. For example, a system implemented in accordance with embodiments of the invention may include an audio input device to receive audio signals generated by the production, and audio captured by the audio input device may be processed to identify particular sounds which take place during an event. Such processing may be performed in any suitable manner. As an example, some embodiments may employ one or more machine learning models to recognize characteristics of one or more sounds associated with the events of the production as described further with respect to FIG. 4. For example, the characteristics of the one or more sounds may include frequencies, volume or amplitude, duration, or any other characteristics of the sounds associated with the events.

As an illustrative (but non-limiting) example, in some embodiments, a production may be a movie. A movie generally has a predetermined sequence of known events (e.g., opening credits, a sequence of scenes, a sequence of events within a particular scene, etc.). Each such event may have various characteristics which make the event susceptible to identification. For example, a scene in a movie may include a series of sounds (e.g., a portion of the soundtrack, a snippet of dialogue, one or more sound effects, etc.) and/or visual content (e.g., one or more characters on screen, a scene change, effects such as explosions, etc.). Act 104 may thus involve recognizing a particular event based on this and/or other information. For example, one characteristic of a particular event in a movie may be that it includes one or more sounds which are indicative of an explosion. Other characteristics of the event may include that it includes one or more visual cues indicative of an explosion (e.g., the movie screen getting brighter, the presence of a smoke cloud, etc.). Other characteristics of the event may include that particular sensor data is captured during or right after the event, such as sensor data indicating that multiple seats in the theater leaned back at the same time, perhaps indicating surprise by audience members in those seats. Act 104 may involve recognizing occurrence of an event based in part on one or more of these and/or other characteristics.

In some embodiments, act 104 may involve recognizing plural events. In this respect, it will become apparent from the description that follows that one reason for recognizing the occurrence of one or more events is to determine when signals are to be emitted to produce a portion of a distributed manifestation to coincide with another event. The Assignee has appreciated that in some cases, recognition of a single event may not provide sufficient information to know when the signals are to be emitted. For example, if it is known that the playback speed of a movie could vary over time, then recognition of one event may not provide enough information to determine when signals are to be emitted to produce an effect which precisely corresponds with another event in the future. The Assignee has also appreciated that in some circumstances, distinguishing one event from another in sequence may be difficult due to similarities between the events. In these cases, recognizing one or more other events surrounding the events in question may aid in distinguishing one from the other. As such, act 104 may, in some embodiments, involve recognizing multiple events.

At the completion of act 104, representative process 100 then proceeds to act 106, wherein the placement of the particular event(s) within the overall sequence is determined. This may be accomplished in any suitable fashion. For example, as noted above, details of the predetermined sequence of events of a production (e.g., the order in which events occur, a duration of each event, information regarding any overlap between events, and/or any other suitable details) may be held in storage, and retrieved to determine where in the sequence the particular event(s) reside(s).

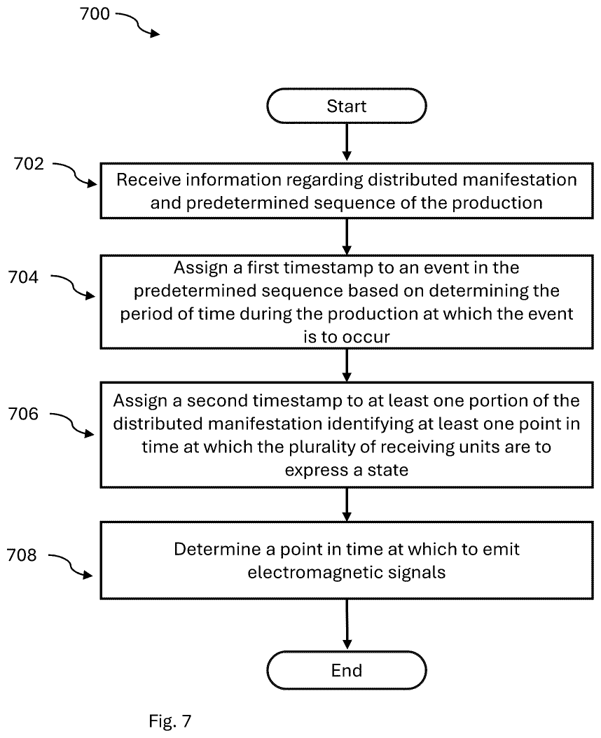

At the completion of act 106, representative process 100 proceeds to act 108, wherein one or more times at which to emit signals to produce a portion of the distributed manifestation to coincide with an event are determined. As noted above, some embodiments may provide for emitting signals so as to produce a portion of the distributed manifestation coincident with a subsequent event. In such embodiments, based on the recognized occurrence of one or more events in the act 104 and the determination of a placement of the event(s) in the predetermined sequence, a later point in time at which signals are to be emitted may be determined (at least initially, at this point in time may change as the production continues to unfold). Some embodiments may provide for emitting signals so as to produce a portion of the distributed manifestation coincident with the event(s) recognized in act 104. In this case, based on the recognized occurrence of one or more events in the act 104 and the determination of a placement of the event(s) in the predetermined sequence, a point in time immediately following the recognition and determination may be determined. As described in further detail below with reference to FIG. 7, the determination of one or more times at which signals are to be emitted may result in a timestamp being created signifying the determined time(s).

Some embodiments of the invention may account for external factors in determining the point(s) in time at which electromagnetic signals are to be emitted. In this respect, the Assignee has appreciated that the generation of control data, transmission of control data, emission of the electromagnetic signals, and processing of the electromagnetic signals by receiving units may each take a certain amount of time, and that the amount of time may vary based at least in part on the hardware and/or components involved. As such, some embodiments of the invention may estimate the amount of time needed to accomplish these and/or other tasks so as to issue instructions to emit signals far in enough advance before the signals are to be sent to produce effects which coincide precisely with a designated event. For example, the determined point in time at which to send the electromagnetic signals may precede the time that the effect of the distributed manifestation is to occur to account for any time lag introduced by external factors.

At the completion of act 108, representative process 100 proceeds to act 110, wherein electromagnetic signals are caused to be emitted to receiving units during the production at the point(s) in time determined in the act 108. This may be performed in any of numerous ways, such as by using one or more of the techniques described in the '391 patent, and/or other techniques. In some examples, control data may be sent to one of more emission units. In some embodiments, the control data may identify the point(s) in time determined in act 108 when individual emission units are to emit the electromagnetic signals. In embodiments wherein directional signals are used, control data may define how and when any emission unit(s) are to move while transmitting signals so as to reach one or more designated areas of the environment. The emission unit(s) may then utilize the control data to properly transmit the electromagnetic signals to the receiving units to produce the distributed manifestation coincident with the production.

At the Completion of Act 110, Representative Process 100 Completes.

It should be appreciated from the description above that some systems implemented in accordance with the embodiments may recognize the occurrence of one event so as to emit signals to produce an effect which coincides with another, subsequent event, and some systems may recognize occurrence of an event and emit signals immediately thereafter so as to produce an effect in real-time. It should also be appreciated, however, that the invention is not limited to implementing only one of these approaches, and that a system may be configured to do both.

It should further be appreciated that although representative process 100 is described above as being performed once, it may be performed any suitable number of times as a production takes place, to achieve any suitable ends. For example, in some embodiments, representative process 100 may be performed once, such as near the start of a production. In other embodiments, representative process 100 may be performed multiple times during a production. As one example, representative process 100 may be performed continually as the production unfolds, so that as new events in the production are recognized, the time(s) at which signals are to be emitted to produce later effects are identified with greater precision than if the time(s) had been identified at or near the start of the production. As another example, representative process 100 may be performed periodically during the course of a production, such as every 10 minutes, every 5 minutes, every 1 minute, etc. The invention is not limited to performing representative process 100 any particular number of times or at any particular periodicity.

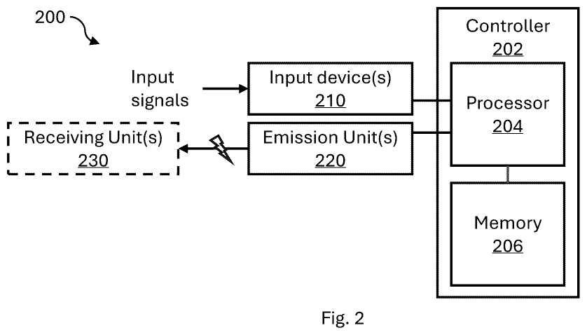

FIG. 2 depicts a block diagram of a representative system 200 for generating a distributed manifestation coincident with a production, according to some embodiments. Representative system 200 may include a controller 202 having a processor and memory, input device(s) 210, and emission unit(s) 220. In some embodiments, representative system 200 may include receiving unit(s) 230. As indicated in FIG. 2, however, in some embodiments representative system 200 may not.

In representative system 200, input device(s) 210 may be configured to receive one or more input signals associated with the production and events of the production. The input signals may be any suitable signals, including but not limited to audio signals, visual signals, haptic signals, olfactory signals, and/or signals produced by one or more sensors configured to capture information regarding the environment. As such, input device(s) 210 may include any suitable input device(s) such as microphones, cameras, sensors, or otherwise that may capture the input signals related to the production or the environment. In some embodiments, the input device(s) 210 may be a direct input device enabling direct data communications between a device executing the production and the controller 202 so that controller 202 may receive signals regarding the production directly from the device. For example, when the production is a movie, the device executing the production may include a projector system having a video processor and a sound processor (e.g., JSD-60, JSD-80, JSD-100, DCP-100 cinema sound processors). A direct input device 210 may connect the projector system to controller 202 so that controller 202 may receive audio and video data of the movie from the projector system directly without the need for intermediary input devices such as cameras and microphones. In some embodiments, a direct input device 210 may include a USB cable, RCA cable, auxiliary jack cable, or any other suitable cable for direct line input. In some embodiments, a direct input device 210 may be a wireless transceiver configured to receive data over a wireless communication network. For example, a direct input device 210 may be configured to receive audio and video data over Wifi, Bluetooth, or any other suitable wireless communication protocol, whether no known or later developed.

Controller 202 may be configured to perform various methods and acts as described in FIGS. 1 and 3-8. In some embodiments, controller 202 may include on or more processors 204, and one or more non-transitory computer-readable storage media (e.g., memory 206 and one or more non-volatile storage media) and, optionally, a display (not shown). The processor 204 may control writing data to and reading data from the memory 206 in any suitable manner, as the aspects of the invention described herein are not limited in this respect. In some embodiments, the controller 202 may also be a complete system on module (SOM), including CPU, GPU, memory, and any other components in a system.

To provide the functionality and/or perform the techniques described herein, the processor 204 may execute one or more instructions stored in one or more computer-readable storage media (e.g., memory 206, other storage media, etc.), which may serve as non-transitory computer-readable storage media storing instructions for execution by the processor 204. In connection with techniques described herein, program code used to generate the distributed manifestation coincident with a production may be stored on one or more computer-readable storage media of controller 202 (e.g., memory 206). Processor 204 may execute any such code to provide any techniques as described herein. Any other software, programs or instructions described herein may also be stored and executed by computer system 200.

Controller 202 may be configured to receive the input signals captured by input device(s) 210 to generate a distributed manifestation coincident with a production. Processor 204 may be configured to receive the input signals, process the input signals to generate control data to produce the distributed manifestation coincident with the production, and send to control data to emission unit(s) 220 to generate the distributed manifestation coincident with the production. For example, processor 204 may be configured to perform representative process 100 for generating a distributed manifestation coincident with a production as described with reference to FIG. 1.

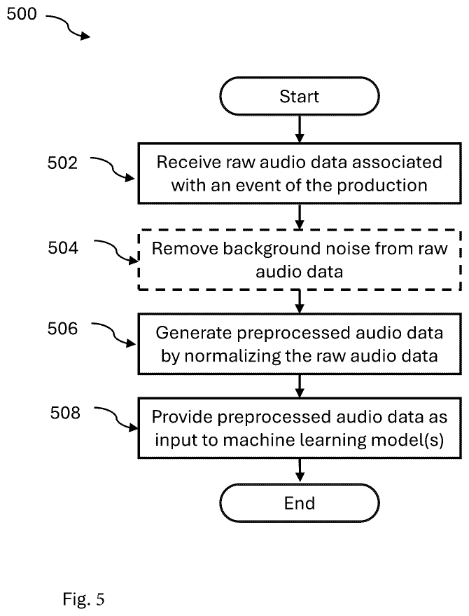

In some embodiments, processor 204 may execute one or more machine learning models for recognizing the occurrence of an event based on one or more of its characteristics. More specific examples of using one or more machine learning models to recognize occurrence of an event are described below with reference to FIGS. 4 and 5.

Memory 206 may be configured to store any suitable information for use by processor 204 in performing any of the processes described herein. For example, data relating to a distributed manifestation may be stored in memory 206 for use by the processor 204 in generating control data for controlling emission unit(s) 220 to generate signals for producing the distributed manifestation according to any of the embodiments described herein. The data may, for example, identify the signals which are to be emitted to cause receiving units to change state to produce the distributed manifestation, and how and when the emission unit(s) 220 are to emit said electromagnetic signals such as the frequency to transmit the signals.

Controller 202 may be implemented in any of numerous ways. For example, controller 202 may be implemented using hardware, software or a combination thereof. When implemented as software, software code may be executed on any suitable processor or collection of processors, whether provided in a single computer or distributed among multiple computers. When implemented using dedicated or general-purpose hardware, such hardware may be programmed using microcode or software to perform the functions described herein, and/or other functions.

In representative system 200, emission unit(s) 220 may be configured to transmit electromagnetic signals to receiving unit(s) 230 within the environment so as to create the distributed manifestation, according to control data generated by controller 202. In some embodiments, the emission unit(s) 220 may be configured to project non-directional electromagnetic signals over the entire area of the environment. The non-directional electromagnetic signals may, for example, fall within the radio frequency (RF) range.

In some embodiments, the electromagnetic signals may be directional signals and the emission unit(s) 220 may each be configured to transmit the directional signals to a subset of the receiving unit(s) 230 in a localized area of the environment. As such, multiple emission unit(s) 220 configured to project directional signals to different localized areas of the environment may be used so that the directional signals are projected throughout the entire environment. The emission unit(s) 220 may be configured to transmit directional signals which, for example, have wavelengths in the infrared portion of the spectrum to receiving unit(s) 230 configured to process signals with infrared wavelengths. The directional signals may be encoded with information that cause the receiving unit(s) 230 to manifest a change in state to produce an effect of the distributed manifestation when the signals are received and processed by receiving unit(s) 230. In some embodiments, one or more of emission unit(s) 220 may be configured to change position over time, so as to transmit the directional signals toward different localized areas of the environment over time. For example, an emission unit 220 may be affixed to a support structure within the environment, but may be configured to pan, tilt, zoom in and/or out, or move along a fixed path defined by the support structure or otherwise. In other embodiments, an emission unit 220 may be transported by an operator, for example, as a handheld emission unit, and may project directional signals toward different localized areas within the environment over time as the operator changes the orientation of the emission unit 220.

As discussed above and further herein, receiving unit(s) 230 may be configured to receive and process electromagnetic signals from emission unit(s) 220 to manifest a change in state of the receiving unit 230 to produce at least a portion of the distributed manifestation. The change in state may be any suitable change in state to produce the desired effects of the distributed manifestation. For example, the change in state may include visual effects (e.g., lighting up a particular color), auditory effects, haptic effects (e.g., buzzing, vibrating, pulsing, etc.), and/or olfactory effects. In some embodiments, a change in state may be to cause a first receiving unit to communicate with a second receiving unit. For example, the first receiving unit may issue commands to or receive commands from the second receiving unit, and/or discern one or more characteristics concerning the second receiving unit, such as its location, distance from the first receiving unit, etc.

Any suitable number and type of receiving unit(s) 230 may be used to produce a distributed manifestation. A receiving unit may reside at a fixed location in the environment (e.g., in a seat, on a physical structure, etc.), be a wearable receiving unit, and/or take any other suitable form(s). A wearable receiving unit(s) 230 may comprise a wristband, badge, pendant and/or any other suitable wearable implementation to be worn by a guest at the environment. In some embodiments, a receiving unit 230 may be adapted to be worn or otherwise transported by an attendee to the production, although the invention is not limited in that respect.

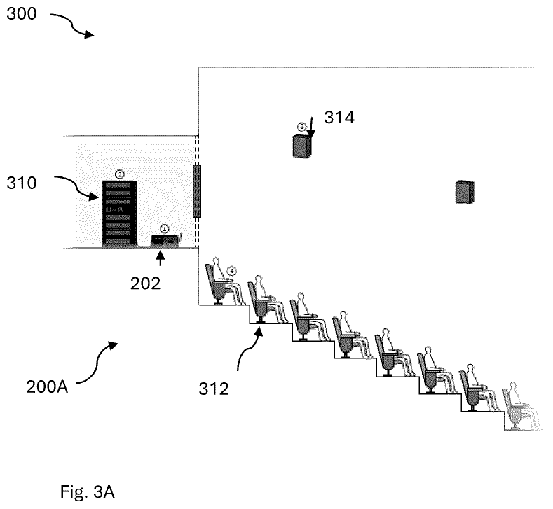

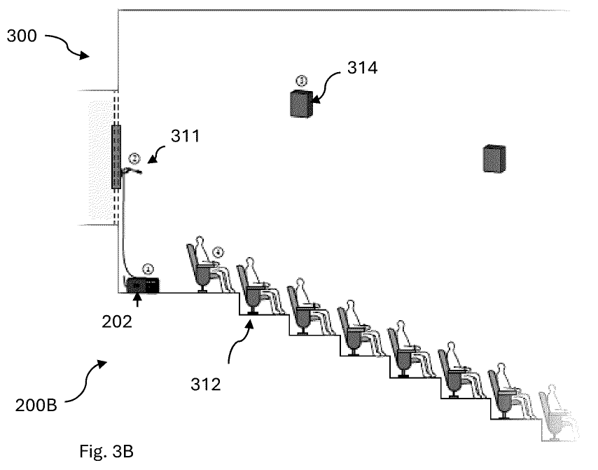

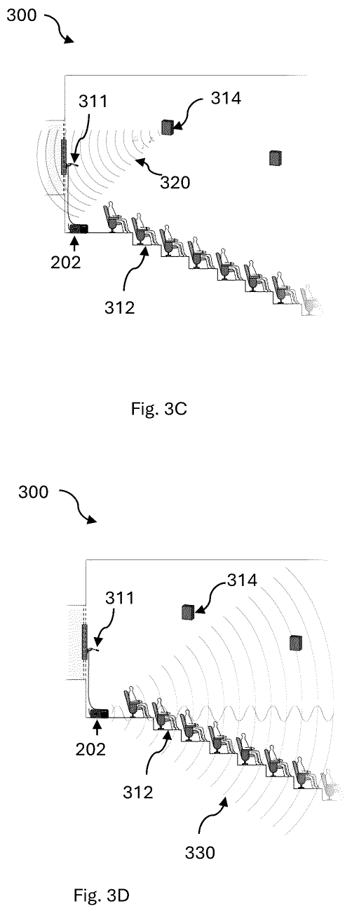

FIG. 3A depicts a representative arrangement of components 200A for generating a distributed manifestation in an environment 300 coincident with a production occurring in the environment, according to some embodiments. The arrangement 200A shown in FIG. 3A includes production control unit 310, seats 312, and speaker(s) 314. Environment 300 shown in FIG. 3A may be, for example, a movie theater. As such, production control unit 310 may be a projector system having a video processor and an audio processor. Production control unit 310 may be connected, through one or more wired and/or wireless connections, to controller 202 as described above. In some embodiments, controller 202 may be placed proximate to production control unit 310 to facilitate a wired or wireless connection as described above. However, the invention is not limited to being implemented in this manner, as controller 202 may reside in any suitable location relative to production control unit 310.

Environment 300 shown in FIG. 3A includes seats 312 which allow attendees to view, hear and feel the production. However, embodiments of the invention are not limited to being implemented in an environment with seats. For example, an environment may include areas where attendees congregate in open floor space, on benches, etc. In environments which include seats 312, receiving units (not pictured) may be placed at or near each seat 312, such as by being physically integrated with each seat 312.

FIG. 3B depicts another representative arrangement of components 200B for generating a distributed manifestation in an environment 300 coincident with a production occurring in the environment, according to some embodiments. The arrangement 200B shown in FIG. 3B differs from arrangement 200A shown in FIG. 3A in that the input device used by controller 202 includes microphone 311 configured to capture audio produced in the environment, including production audio produced by speakers 314 and sound produced by attendees. In the example shown, microphone 311 is located on a wall to enable it to capture audio from the environment. For example, microphone 311 may be placed proximate to speaker 314 or may be placed in any location that can receive the audio signals emitted by speaker 314. As controller 202 is not connected to a production control unit 310 as in FIG. 3A, controller 202 can be placed in any suitable location at which microphone 311 may capture audio data from the environment 300, including speakers 314 and the attendees. For example, as shown in FIG. 3B, controller 202 may be placed in the rear of seats 312 in the attendee area. However, the technology is not limited in this regard and the controller 202 may reside in any suitable location in the environment, such as at the front of seats 312, to the sides of seats 312, mounted on a wall (e.g., nearby speakers 314) and/or at any other suitable location.

FIGS. 3C and 3D schematically depict the interaction between a representative system 200B and events occurring in an environment for generating a distributed manifestation in the environment, according to some embodiments. For example, as a production is occurring, speakers 314 may output audio of the production. Audio signals 320 may be received by microphone 311 and subsequently, the captured audio signals may be received by controller 202. Controller 202 may process the captured audio signals using the processes described herein and may generate control data for the emission units to send electromagnetic signals 330 throughout environment 300 so that the receiving units (e.g., at seats 312) may express the proper changes in state to produce the distributed manifestation in environment 300.

In some embodiments, one or more machine learning models may be used to recognize sounds and/or other data associated with an event. FIG. 4 depicts a representative process 400 for using one or more machine learning models to determine if an event includes one or more sounds, according to some embodiments.

Representative process 400 begins with act 402, wherein audio data associated with one or more sounds of a production is received. In some embodiments, audio data may be received directly from a production control unit via a wired or wireless connection as described above. In some embodiments, audio data may be captured during the production, using one or more microphones, sensors and/or input devices.

At the completion of act 402, representative process 400 proceeds to act 404, wherein one or more sounds associated with an event of the production are recognized. In some embodiments, as noted above, recognition may be performed or aided by one or more machine learning models. In some embodiments, the machine learning model(s) may be trained to recognize the sound(s) based on associated characteristics. The characteristics may include, as examples, frequency, a sequence of frequencies constituting a frequency profile, amplitude, duration, and/or any other suitable characteristics. As an example, some sounds may be recognized as being associated with an explosion based on a short duration with great amplitude and a frequency profile having many different frequencies. By contrast, other sounds may be recognized as being associated with dialogue based on a longer duration with moderate amplitude and a frequency profile which includes few frequencies.

In some embodiments, a machine learning model may be a deep learning model. A deep learning model may be a neural network classifier having a series of layers with nodes at each layer. The layers may include an input layer configured to receive audio data (e.g., from input device 210 of FIG. 2), one or more hidden layers, and an output layer configured to output a predicted classification of one or more sounds. The hidden layer(s) may include convolutional layers, activation layers, pooling layers, and a fully-connected layer configured to compute classification probabilities of each sound in the audio data. A machine learning model may have any suitable number of layers for recognizing sound signatures associated with the event.

At the completion of act 404, representative process 400 proceeds to act 406, wherein the occurrence of an event is recognized based on the sound(s) recognized in act 404. This may be performed in any of numerous ways. In one example, the information received in act 102 of representative process 100 (FIG. 1) concerning the production may specify that an event includes certain sounds, and so recognizing the sounds leads to recognizing occurrence of the event. In another example, an event may be known to include a particular happening and the recognition in act 404 of sounds indicating or identifying such a happening may result in the event which includes the happening being recognized in act 406. For example, an event which forms part of a movie may be known to include a car chase. A car chase may be recognized based on sounds which are indicative of such a happening in act 404, and as such, the event which is known to include the car chase may be recognized accordingly in act 406.

Some embodiments of the invention may allow for recognition of different events which each include a similar happening, such as different events which each include a separate car chase. Recognizing each event may be performed, for example, by also recognizing other characteristics of each event (e.g., sounds other than the car chase present in each event), and using the other characteristics, or a combination of the other characteristics and the recognized sounds associated with a car chase, to identify each event. One or more machine learning models may be employed to recognize each event. For example, where two or more events include similar happenings and thus have similar associated sounds, a machine learning model may determine a likelihood that each event is occurring and conclude that the event which is occurring is the one with the highest associated likelihood.

At the Completion of Act 406, Representative Process 400 Completes.

The Assignee has appreciated the desirability of producing a distributed manifestation in environments having varying characteristics. For example, different environments may offer widely varying acoustics, have very different physical configurations, provide audio hardware of varying quality, and be used to host very different types of productions. All of these factors may influence the ability to effectively capture audio for use in recognizing sounds and events. For example, some environments, such as closed structures with large amounts of attendees, may be more prone to background noise. Some environments may offer poor acoustics and/or antiquated audio hardware which could complicate sound capture. Some may employ mixing techniques which could make it difficult to recognize certain sounds.

To address these and other issues, FIG. 5 depicts a representative process 500 for preprocessing audio data to account for the potentially varying characteristics of an environment in which a production occurs, according to some embodiments. At the start of representative process 500, raw audio data associated with an event of the production is received. This may be performed in any suitable way. For example, raw audio data may be captured via an input device such as a microphone, or directly from production control hardware over a wireless or wired connection.

Optionally, in act 504, background noise may be removed from the raw audio data captured in act 502. Background noise may include, for example, noise from attendees talking or moving, inherent noise, static from components like speakers, etc., and may muddle or obscure sounds of a production and make recognition difficult. As such, in some embodiments, background noise in received raw audio data may be identified and removed (e.g., using processor 204 of system 200, FIG. 2, using known techniques. For example, some embodiments may provide for converting raw audio data to an audio spectrogram indicating the amplitude and frequency of different sounds at different times. Through spectrogram analysis during periods of low production volume, the typical frequencies and volume of background noise occurring in the environment may be identified and removed.

Representative process 500 proceeds to act 506, wherein preprocessed audio data is generated by normalizing the raw audio data. This may be performed, for example, by determining a maximum sound level in raw audio data, and dividing the sound level at each point in time in the raw audio data by the maximum sound level. The maximum sound level may be identified, for example, by converting raw audio data to a spectrogram, and determining a peak amplitude of the raw audio data in the spectrogram. Normalizing raw audio data may enable some embodiments of the invention to account for varying characteristics of the environments in which a production may occur.

At the completion of act 506, representative process 500 proceeds to act 508, wherein preprocessed audio data is provided as input to one or more machine learning models, which may be trained to recognize sounds associated an event of a production as described above.

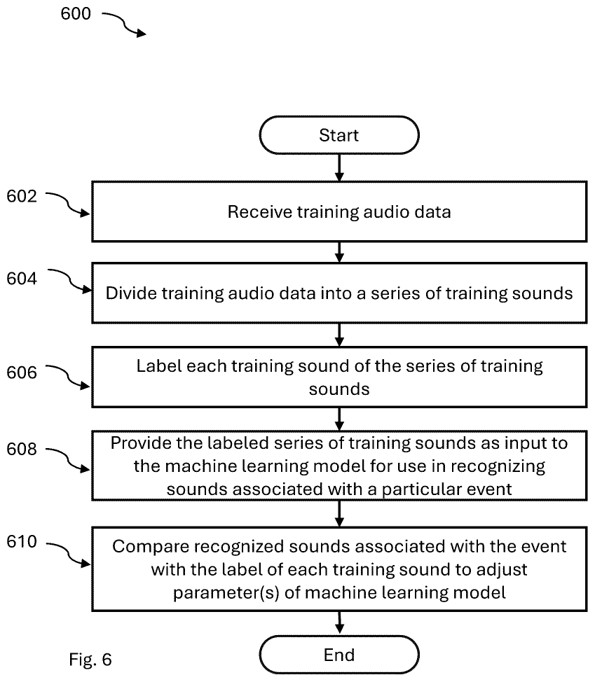

FIG. 6 depicts a representative 600 for training a machine learning model to recognize sounds associated with events in a production, according to some embodiments. At the start of representative process 600, audio data is received in act 602 for training the model. Given the widely varying types of productions with which one may wish to synchronize a distributed manifestation, in some embodiments, a machine learning model may be trained for use in recognizing sounds in a particular type of production. Of course, the invention is not limited to such an implementation. For example, a model may be a foundational model trained to recognize sounds generally and may be fine-tuned to recognize sounds in a particular type of production using representative process 600. As such, training audio data may include an audio track of the production. For example, when the production is a movie, the training audio data may include the audio portion of the film, and/or the audio portion of other (e.g., similar) films. With other types of productions, the model may be trained using sounds that are typical of those types of productions.

At the completion of act 602, representative process 600 proceeds to act 604, wherein the training audio data is divided into a series of training sounds. In some embodiments, the training audio data may include a series of sounds with which the machine learning model may be trained. Each sound may be divided from the training audio data to generate a series of training sounds. Each sound in the series of sounds may correspond to a single training sound. However, the technology is not limited in this respect and multiple sounds of the series of sounds may correspond to a single training sound or a single sound in the series of sounds may correspond to multiple training sounds (e.g. a first portion of the sound may correspond to a first training sound and a second portion of the sound may correspond to a second training sound).

In other embodiments, the training audio data may be divided into snippets of sounds with the same duration to generate the series of training sounds. For example, each training sound may include a 1 second (or less than one second, 2 seconds, 5 seconds, 10 seconds) snippet of the training audio data. As such, if the training audio data is 10 seconds, the series of training sounds may include 10×1 second training sounds. In some embodiments, the training sounds may include overlapping snippets. The first training sound may occur during a time period that overlaps with a time period of the second training sound and the second training sound may occur during a time period that overlaps with the time periods of both the first training sound and the second training sound. In that way, if the training audio data is 10 seconds, the series of training sounds may include more than 10×1 second training sounds. For example, the first training sound may include a sound snippet occurring over a time period of t=0 s to t=1 s of the training audio data, the second training sound may occur over a time period of t=0.5 s to t=1.5 s, and the third training sound may occur over a time period of t=1 s to t=2 s. However, in different embodiments, the overlap between successive training sounds may differ as the technology is not limited in that respect. For example, the first training sound may occur over a time period of t=0 s to t=1 s, the second may occur over a time period of t=0.75 s to 1.75 s, and the third may occur over a time period of t=1.5 s to t=2.5 s, so that the center 0.5 s of the second training sound does not overlap with either the first or third training sound. In that way, the machine learning model may be trained to recognize the sounds and sound signatures of the various events in the predetermined sequence in different contexts, which may improve the accuracy of the machine learning model for use in recognizing the events and sounds associated with the events.

At the completion of act 604, representative process 600 proceeds to act 606, wherein each of the training sounds of the series of training sounds is labeled. Each training sound may be given a particular label associated with the training sound. For example, each training sound may be associated with a particular event such as an explosion or a car crash and the label may correspond to that event.

At the completion of act 606, representative process 600 proceeds to act 608, wherein the labeled series of training sounds are provided as input to a machine learning model which is to be trained for use in recognizing sounds associated with a particular event. The machine learning model may take the labeled series of training sounds as input and, for each of the training sounds, may predict what event the training sound is associated with. The machine learning model may then provide the prediction for each training sound as output to the system for comparison with the label associated with the training sound in act 608.

At the completion of act 608, representative process 600 proceeds to act 610, wherein the recognized sounds associated with the event are compared with the label of each training sound to adjust one or more parameters of the machine learning model. For example, the machine learning model may make a prediction of the training sound being associated with a particular event. However, the label may indicate that the training sound is associated with a second, different event. As such, comparing the prediction with the label may indicate that the machine learning model's prediction was incorrect and one or more parameters of the machine learning model may be adjusted. For example, in the event that a prediction is incorrect, the weights and activation functions between different nodes and layers of the machine learning model may be adjusted to reduce the probability of the same prediction occurring again when analyzing the particular training sound. Similarly, when the comparison of the prediction and the label indicates that the prediction was correct, the parameters of the machine learning model may be adjusted to strengthen that prediction and increase the likelihood of the prediction being made again in the future when analyzing the training sound. For example, the weights and activation functions may be adjusted using a gradient descent process.

In some embodiments of the technology described herein, only one machine learning model, trained to recognize the sounds in a particular production, may be used. In other embodiments, multiple machine learning models may be used. For example, each of the machine learning models may be trained to recognize events of a different type in a production. As one example, a first machine learning model may be trained to recognize sounds indicating dialogue, a second machine learning model may be trained to recognize sounds indicating an explosion, and a third machine learning model may be trained to recognize certain visual stimuli. Multiple machine learning models may, for example, be used together in the same production.

In some embodiments, the machine learning model may be trained to recognize sounds in a particular type of production that can be applied to any production of that type. For example, a first machine learning model may be trained to recognize sounds within movies, whereas a second machine learning model may be trained to recognize sounds during sporting events, and a third machine learning model may be trained to recognize sounds during musical performances. In other productions the machine learning model may be trained to recognize particular types of events in a production. In some embodiments, the machine learning model may be a foundational model trained to recognize sounds across different productions and types of productions. For example, the training audio data may include audio from movies, musical performances, sporting events, or any other type of production. When being used for a particular production, the foundational model may be fine-tuned for the particular production by being further trained on sounds from the particular production, for example, on a portion of the soundtrack, or for sounds associated with events of the particular production.

Although the above representative process 600 is described with respect to training the machine learning model to recognize sounds, the technology described is not limited in this respect. For example, representative process 600 may be used to train a model to recognize any other suitable characteristic of an event. For example, rather than using training audio data, training video data may be utilized in representative process 600, which may be divided into a series of training videos, and representative process 600 may be used to train the machine learning model on the series of training videos in a similar manner as described above.

FIG. 7 depicts a representative process 700 for determining a point in time at which to cause electromagnetic signals to be emitted to produce a distributed manifestation which is synchronized with a production, according to some embodiments. At the start of representative process 700, information regarding the production and the distributed manifestation is received in act 702. In some embodiments, the information regarding the production may include the predetermined sequence of events and information related to the events of the predetermined sequence (e.g., a duration of each event, an order for the events in the sequence, etc.). Information regarding the distributed manifestation may include the effects which are to be produced coincident with certain events, the signals that are to be sent to produce effects, the duration and timing of the effects, or any other suitable information. In some embodiments, the information concerning the distributed manifestation may include information associated with hardware and/or software components used to produce the production and the distributed manifestation including, but not limited to, processing speeds, configuration of components, or any other suitable information, so that systems implemented in accordance with some embodiments of the invention may appropriately account for any lag introduced by various components, as well as variations between environments in which productions may be produced.

At the completion of act 702, representative process 700 proceeds to act 704, wherein a first timestamp is assigned to a particular event in the overall sequence based on a determined time when the event is estimated to occur. This may be performed in any of numerous ways, such as by recognizing the event, and knowing the overall sequence of events comprising the production and the duration of each event. For example, if the particular event is known to be the first event in the overall sequence, then the event may be assigned timestamp t=0 s. If the particular event were known to be the second event in the sequence, and if it were known that the duration of the first event is 10 seconds, then the timestamp assigned to the particular event may be t=10 s. Some embodiments of the invention may account for gaps between events in assigning a timestamp to a particular event. For example, if it were known that the duration of the second event is seven seconds and that there is a three second gap between the second and third events, then the timestamp assigned to the third event may be t=20 s.

In some embodiments, rather than assigning timestamps to events as the production is unfolding, timestamps may be assigned to events beforehand based on known information, so as to potentially reduce computational overhead.

At the completion of act 704, representative process 700 proceeds to act 706, wherein a second timestamp is assigned to a portion of the distributed manifestation, identifying a time when receiving units are to express a state as part of the distributed manifestation. Similar to the procedure described above for assigning timestamps to events, each portion of the distributed manifestation may be assigned a separate timestamp. In some embodiments, a timestamp for a portion of the distributed manifestation may be determined in relation to the timestamp for an event with which the portion should coincide. Using an example given above to illustrate, if a portion of the distributed manifestation is to occur at the start of the second event (i.e., with timestamp t=10 s), then the timestamp assigned to the portion may be t=10 s. If the end of a portion which has a duration of four seconds is to coincide with the end of the second event (i.e., with timestamp t=10 s, and duration of seven seconds), then the timestamp assigned to the portion may be t=13 s. If the end of a portion having a duration of four seconds is to coincide with the start of the second event, then the timestamp assigned to the portion may be t=6 s. A timestamp may be assigned to a portion of a distributed manifestation in relation to an event in any suitable way, as the invention is not limited in this respect.

At the completion of act 706, representative process 700 proceeds to act 708, wherein a point in time at which to instruct emission units to emit signals to produce the portion of the distributed manifestation is determined. This may be performed in any of numerous ways. As one example, if experience indicates that signals are emitted in near real-time after instructions to do so are issued, then the time at which the instructions are to be issued may coincide with the time at which the production is to occur. Continuing with the example above to illustrate, if experience indicates that signals are emitted in near real-time after instructions to do so are issued, and if the timestamp assigned to the considered portion is t=10 s, then the point at which to instruct emission units to emit signals to produce the portion of the distributed manifestation may also be assigned the timestamp of t=10 s. However, if experience indicates that there is a one second lag between when instructions are issued and signals are emitted, and if the timestamp assigned to the considered portion is t=10 s, then the point at which to instruct emission units to emit signals to produce the portion of the distributed manifestation may be assigned the timestamp of t=9 s.

At the completion of act 708, representative process 700 completes.

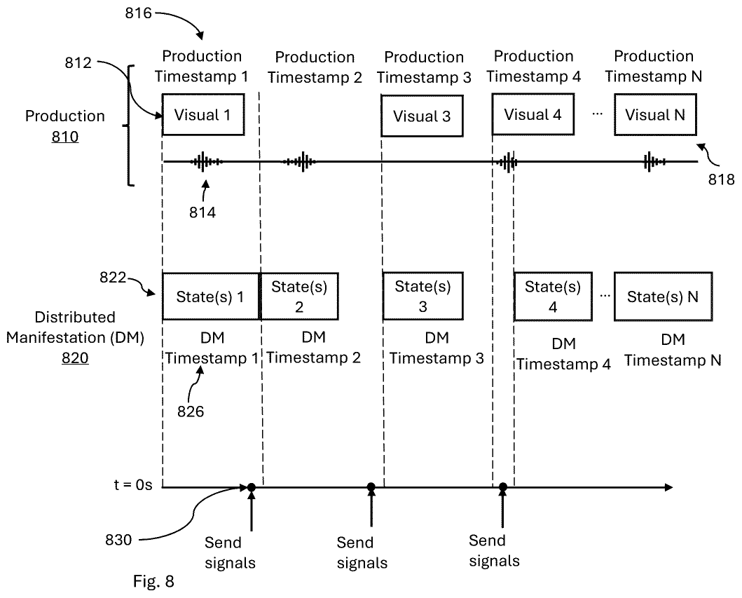

FIG. 8 conceptually depicts an illustrative distributed manifestation 820 produced coincident with a production 810, according to some embodiments. In FIG. 8, production 810 has a predetermined sequence of events 818 which each have characteristics including visuals 812 and sounds 814. The events may have varying durations and characteristics. For example, the first event in the sequence includes visual 812 and sound 814, the second event includes only sound 814, and the third event includes only visual 812. Each event in the sequence is assigned a corresponding production timestamp 818 (i.e., production timestamp 1-N).

Distributed manifestation 820 includes a series of portions which are to occur coincident with events of the production. The portions may include states expressed by receiving units at a point in time. As described above with reference to FIG. 7, each portion may be assigned a DM timestamp 826 (i.e., DM timestamp 1-N) indicating when the portion is to occur.

As noted above, in some embodiments, a portion of the distributed manifestation occurs at the same time as an event of the production. In this respect, in FIG. 8 depicts state(s) 1 as occurring at the same time as the first event. As such, the production timestamp 816 assigned to the event and the timestamp 826 assigned to the portion are the same (e.g., t=Ts). However, in other circumstances, a portion of the distributed manifestation may occur before or after a particular event. For example, in FIG. 8 state(s) 4 start(s) after the fourth event begins, and so the DM timestamp 4 may reflect a different point in time than the production timestamp 4.

It should be appreciated that the systems and methods described herein are not limited to being used to producing distributed manifestations coincident with a movie. For example, embodiments of the invention may be used to synchronize a distributed manifestation with a musical performance, sporting event, exhibit, and/or any other suitable production. Similarly, the systems and methods described herein are not limited to being used to producing distributed manifestations in a movie theater, and may be employed in any suitable environment, such as a stadium, arena, concert venue, amphitheater, and/or any other suitable environment.

The various methods or processes outlined herein may be implemented via software which is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework. The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the description provided herein be regarded as including such equivalent constructions insofar as they do not depart from the spirit and scope of the disclosed subject matter.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A method of generating a distributed manifestation coincident with a production, the distributed manifestation comprising a plurality of receiving units expressing a state as a result of processing electromagnetic signals received from at least one emission unit, the production comprising a plurality of events occurring in a predetermined sequence, the method comprising acts of:
(A) recognizing occurrence of a particular event of the plurality of events, the recognizing comprising determining that the particular event includes one or more sounds;
(B) determining when in the predetermined sequence the particular event is to occur;
(C) determining at least one point in time during the production at which to send electromagnetic signals to the plurality of receiving units to produce at least a portion of the distributed manifestation; and
(D) causing electromagnetic signals to be sent to the plurality of receiving units during the production at the determined at least one point in time.

2. The method of claim 1, wherein expressing a state comprises producing one or more effects associated with the state, the one or more effects including at least one of: a visual effect, an auditory effect, an olfactory effect, and/or a haptic effect.

3. The method of claim 1, wherein the electromagnetic signals are non-directional signals to be sent to one or more subsets of the plurality of receiving units.

4. The method of claim 1, wherein the act (A) comprises using at least one machine learning model to recognize characteristics of one or more sounds associated with the event based at least in part on audio data associated with the one or more sounds.

5. The method of claim 4, wherein the act (A) further comprises:
generating preprocessed audio data by normalizing the audio data associated with the one or more sounds to account for one or more characteristics of an environment in which the production takes place; and
providing the preprocessed audio data to the at least one machine learning model.

6. The method of claim 5, wherein generating the preprocessed audio data comprises generating an audio spectrogram based on the audio data associated with the one or more sounds.

7. The method of claim 5, wherein the one or more characteristics of the environment include one or more of: acoustics of the environment, a physical configuration of the environment, audio hardware utilized by the environment, and/or a level of background noise present in the environment at the occurrence of the particular event.

8. The method of claim 4, wherein the at least one machine learning model is trained to recognize characteristics of one or more sounds associated with the event using training audio data associated with the one or more sounds of each event of the plurality of events.

9. The method of claim 8, wherein training the machine learning model comprises:
dividing the training audio data into a series of training sounds;
labelling each training sound of the series of training sounds; and
providing the labelled series of training sounds for use in recognizing the particular event.

10. The method of claim 9, wherein each training sound of the series of training sounds comprises a one second duration of the training audio data.

11. The method of claim 9, wherein each one training sound of the series of training sounds occurs during a time period which overlaps with a time period during which a training sound immediately preceding the one training sound in the series occurs, and with a time period during which a training sound immediately subsequent to the one training sound in the series occurs.

12. The method of claim 1, wherein the determining that the particular event includes one or more sounds in the act (A) comprises receiving audio input comprising the one or more sounds via at least one of a microphone and direct input.

13. The method of claim 1, wherein the recognizing in the act (A) further comprises recognizing a characteristic of the particular event other than one or more sounds.

14. The method of claim 13, wherein the characteristic of the particular event other than one or more sounds comprises one or more visuals produced as part of the particular event.

15. The method of claim 1, wherein a rate at which the predetermined sequence occurs varies, and wherein the act (B) comprises determining a period of time during the production when the particular event is to occur.

16. The method of claim 15, wherein the act (B) further comprises assigning a first timestamp to the particular event identifying a period of time during the production at which the particular event is to occur within an overall period of time in which the production is to take place.

17. The method of claim 16, wherein the act (C) further comprises:
assigning a second timestamp to at least one portion of the distributed manifestation, the second timestamp identifying at least one point in time at which the plurality of receiving units are to express a state to produce the at least one portion of the distributed manifestation; and
determining a point in time at which to send the electromagnetic signals based at least in part on the second timestamp.

18. The method of claim 1, wherein the act (C) comprises determining a point in time at which the plurality of receiving units are to express a state to produce at least a portion of the distributed manifestation, and the act (D) comprises instructing the at least one emission unit to emit the electromagnetic signals at substantially the determined point in time.

19. The method of claim 1, wherein the act (C) comprises determining a point in time at which the plurality of receiving units are to express a state to produce at least a portion of the distributed manifestation, and the act (D) comprises instructing the at least one emission unit to emit the electromagnetic signals prior to the determined point in time.

20. The method of claim 1, wherein the method is for use in a system which comprises the plurality of receiving units.

21. The method of claim 1, wherein the production comprises a movie.

22. A system for controlling generation of a distributed manifestation coincident with a production, the distributed manifestation comprising a plurality of receiving units expressing a state as a result of processing electromagnetic signals, the production comprising a plurality of events occurring in a predetermined sequence, the system comprising:
at least one emission unit configured to emit electromagnetic signals to the plurality of receiving units; and
at least one computer processor, programmed to:
recognize an occurrence of a particular event of the plurality of events, the recognizing comprising determining that the particular event includes one or more sounds;
determine when in the predetermined sequence the particular event is to occur;
determine at least one point in time during the production at which to send electromagnetic signals to the plurality of receiving units to produce at least a portion of the distributed manifestation; and
cause the at least one emission unit to emit electromagnetic signals to the plurality of receiving units during the production at the determined at least one point in time.

23. The system of claim 22, further comprising the plurality of receiving units configured to express a state to produce at least the portion of the distributed manifestation.

24. The system of claim 23, wherein expressing a state comprises producing one or more effects associated with the state, the one or more effects including at least one of: a visual effect, an auditory effect, an olfactory effect, and/or a haptic effect.

25. The system of claim 22, wherein the electromagnetic signals are non-directional signals to be sent to one or more subsets of the plurality of receiving units.

26. The system of claim 22, wherein the at least one computer processor is programmed to recognize the occurrence of the particular event using at least one machine learning model trained to recognize characteristics of one or more sounds associated with the event based at least in part on audio data associated with the one or more sounds.

27. The system of claim 26, wherein the at least one computer processor is programmed to recognize the occurrence of the particular event by:
generating preprocessed audio data by normalizing the audio data associated with the one or more sounds to account for one or more characteristics of an environment in which the production takes place; and
providing the preprocessed audio data to the at least one machine learning model.

28. The system of claim 27, wherein the at least one computer processor is programmed to generate the preprocessed audio data through generation of an audio spectrogram based on the audio data associated with the one or more sounds.

29. The system of claim 27, wherein the one or more characteristics of the environment include one or more of: acoustics of the environment, a physical configuration of the environment, audio hardware utilized by the environment, and/or a level of background noise present in the environment at the occurrence of the particular event.

30. The system of claim 26, wherein the at least one machine learning model is trained to recognize characteristics of one or more sounds associated with the event using training audio data associated with the one or more sounds of each event of the plurality of events.

31. The system of claim 30, wherein training the machine learning model comprises:
dividing the training audio data into a series of training sounds;
labelling each training sound of the series of training sounds; and
providing the labelled series of training sounds for use in recognizing the particular event.

32. The system of claim 31, wherein each training sound of the series of training sounds comprises a one second duration of the training audio data.

33. The system of claim 31, wherein each one training sound of the series of training sounds occurs during a time period which overlaps with a time period during which a training sound immediately preceding the one training sound in the series occurs, and with a time period during which a training sound immediately subsequent to the one training sound in the series occurs.

34. The system of claim 22, wherein the at least one computer processor is programmed to determine that the particular event includes one or more sounds by receiving audio input comprising the one or more sounds via at least one of a microphone and direct input.

35. The system of claim 22, wherein the at least one computer processor is programmed to recognize the occurrence of the particular event by recognizing a characteristic of the particular event other than one or more sounds.

36. The system of claim 35, wherein the characteristic of the particular event other than one or more sounds comprises one or more visuals produced as part of the particular event.

37. The system of claim 22, wherein a rate at which the predetermined sequence occurs varies, and wherein the at least one computer processor is programmed to determine when in the predetermined sequence the particular event is to occur by determining a period of time during the production when the particular event is to occur.

38. The system of claim 37, wherein the at least one computer processor is programmed to determine when in the predetermined sequence the particular event is to occur further by assigning a first timestamp to the particular event identifying a period of time during the production at which the particular event is to occur within an overall period of time in which the production is to take place.

39. The system of claim 38, wherein the at least one computer processor is programmed to determine the at least one point in time during the production at which to send electromagnetic signals by:
assigning a second timestamp to at least one portion of the distributed manifestation, the second timestamp identifying at least one point in time at which the plurality of receiving units are to express a state to produce the at least one portion of the distributed manifestation; and
determining a point in time at which to send the electromagnetic signals based at least in part on the second timestamp.

40. The system of claim 22, wherein the at least one computer processor is programmed to determine the at least one point in time during the production at which to send electromagnetic signals by:
determining a point in time at which the plurality of receiving units are to express a state to produce at least a portion of the distributed manifestation, and
causing the at least one emission unit to emit electromagnetic signals by instructing the at least one emission unit to emit the electromagnetic signals at substantially the determined point in time.

41. The system of claim 22, wherein the at least one computer processor is programmed to determine the at least one point in time during the production at which to send electromagnetic signals by:
determining a point in time at which the plurality of receiving units are to express a state to produce at least a portion of the distributed manifestation, and
causing the at least one emission unit to emit electromagnetic signals by instructing the at least one emission unit to emit the electromagnetic signals prior to the determined point in time.

42. The system of claim 22, wherein the production comprises a movie.

43. At least one computer-readable storage medium having instructions stored thereon which, when executed by at least one computer processor, cause the at least one computer processor to perform a method of generating a distributed manifestation coincident with a production, the distributed manifestation comprising a plurality of receiving units expressing a state as a result of processing electromagnetic signals received from at least one emission unit, the production comprising a plurality of events occurring in a predetermined sequence, the method comprising acts of:
(A) recognizing occurrence of a particular event of the plurality of events, the recognizing comprising determining that the particular event includes one or more sounds;
(B) determining when in the predetermined sequence the particular event is to occur;
(C) determining at least one point in time during the production at which to send electromagnetic signals to the plurality of receiving units to produce at least a portion of the distributed manifestation; and
(D) causing electromagnetic signals to be sent to the plurality of receiving units during the production at the determined at least one point in time.
